(19) United States
(12) Patent Application Publication
(10) Pub. No.: US 2010/0309066 A1
(43) Pub. Date: Dec. 9, 2010

(54) antenna arrangement for a motor vehicle and method

(76) Inventors: Bernd Flick, Diekholzen (DE); Thomas Schano, Giesen (DE)

Correspondence Address: KENYON & KENYON LLP, ONE BROADWAY, NEW YORK, NY, 10004, US

(21) Appl. No.: 12/746,163

(22) PCT Filed: Oct. 13, 2008
(86) PCT No.: PCT/EP2008/063719

§ 371 Date: Aug. 16, 2010

(30) Foreign Application Priority Data
Dec. 4, 2007 (DE) 10 2007 058 247.3

(51) Int. Cl. H01Q 1/32

(52) U.S. Cl. 343/713

(57) ABSTRACT

In an antenna arrangement for a motor vehicle, a holding device for an add-on part is configured as an antenna by being insulated vis-à-vis a chassis or, if no insulation vis-à-vis the chassis is provided, is configured to accommodate an insulated antenna conductor.

### FIELD OF THE INVENTION

The present invention is based on an antenna arrangement for a motor vehicle or a method for implementing such an antenna arrangement.

### BACKGROUND INFORMATION

It is understood that add-on parts of motor vehicles are used as antennas. European Patent EP 383 017 A2 refers to bumpers for a motor vehicle made of plastic molded parts that carry antenna elements adapted to the bumper contours. There, interconnecting such antenna elements makes a diversity reception possible. The antenna elements are developed as conductor strips or decorative moldings affixed by bonding.

Patent document WO 02/23668 A1 also refers to a bumper antenna arrangement having a conductive area in the bumper. This area forms a slot across from the motor vehicle chassis (body panel), which influences the antenna's directional diagram. Signals for a diversity operating mode may be obtained by antenna connections at several points of the conductive area.

Patent document WO 01/59878 A1 discusses an antenna situated in the exterior mirror of the vehicle. The mirror glass is there divided into segments insulated from one another and is thus pervious to high-frequency signals so that high-frequency signals are able to reach the antenna in the interstice between a metal carrier and the plastic housing of the vehicle's exterior mirror.

### SUMMARY OF THE INVENTION

In the antenna arrangement for a motor vehicle according to the present invention, in which at least one holding device for an add-on part is developed, insulated vis-à-vis a chassis, as an antenna or at least as a part of an antenna or, especially when no insulation is provided vis-à-vis the chassis, is developed to accommodate an insulated antenna conductor, the actual add-on part such as the bumper or the exterior mirror does not have to be reconstructed at great expenditure if it is to accommodate an antenna. Only the holding device for the add-on part must be insulated vis-à-vis the chassis in order to be used as an antenna, e.g. the holding device as a dipole or as a frame antenna or, if such an insulation is not desired, it suffices to accommodate an insulated antenna conductor through the holding device or guide it through if the holding device is developed in a pipe-like fashion.

No additional superstructures are required such that it is possible to retrofit already delivered motor vehicles without great expenditure for assembly. In particular, the antenna arrangement according to the present invention is suitable for additional services such as car-to-car communication or for the communication from vehicles to signal systems for which already existing antennas are not designed or even for motor vehicles, in which conventional antennas cannot be accommodated, for example rear window antennas in trucks. Since trucks are usually equipped with bracket- and pipe-like holding devices for rearview mirrors, these may be readily utilized for an antenna arrangement according to the present invention.

In pipe-like metal holding devices, an insulated antenna conductor may simply be run through or connected to the pipe.

Although the pipe itself has a shielding effect for electromagnetic waves, at least the magnetic field component may be received, as in a conventional frame antenna, having a defined directivity in the direction of the roadway particularly in the case of truck mirror holders, which makes such antennas especially advantageous for communicating with roadside signal systems or toll systems.

In the case of multiple, in particular similar, holding devices, these may be advantageously interconnected to form an antenna system and, using a switching device, allow for a diversity operating mode.

In multiple pipe-like holding devices, it is advantageous to run an in particular insulated antenna conductor through at least two of these holding devices so as to form a loop, which may be used as a loop dipole/folded dipole, frame (loop) antenna. If the antenna conductor is run through or connected to the holding device of the bumper and through the bumper between two such holding devices, such a loop antenna may be advantageously implemented without having to attach additional add-on parts on the bumper. For stable receiving characteristics, the antenna conductor only needs to be fixed in position within the bumper. Since the bumper is normally made of plastic, the antenna loop thus formed is also suitable for receiving the electrical field component.

In multiple, in particular similar, holding devices, these may be advantageously connected as individual elements of a dipole.

Metal holding devices may also be divided in the middle for accommodating an insulation. The individual parts may be set up as the individual parts of a dipole or as individual receiving elements of a diversity receiving device. Here too, a holding device according to the exemplary embodiments and/or exemplary methods of the present invention may form an antenna counterweight vis-à-vis the chassis in order to work like a dipole radiator.

Specific embodiments of the present invention are explained in greater detail with reference to the drawing.

### BRIEF DESCRIPTION OF THE DRAWINGS

FIG. 1 shows holding devices for rearview mirrors of a truck.

FIG. 2 shows a holding device having an intermediate insulation.

FIG. 3 shows a holding device having an antenna conductor running through it.

FIG. 4 shows a holding device having a split interior antenna conductor.

FIG. 5 shows a holding device having an elongated insulation in the area of the crest of the bracket.

FIG. 6 shows a holding device for a bumper.

FIG. 7 shows the use of holding devices for a bumper insulated from the chassis.

FIG. 8 shows antenna conductors running through a holding device for bumpers.

### DETAILED DESCRIPTION

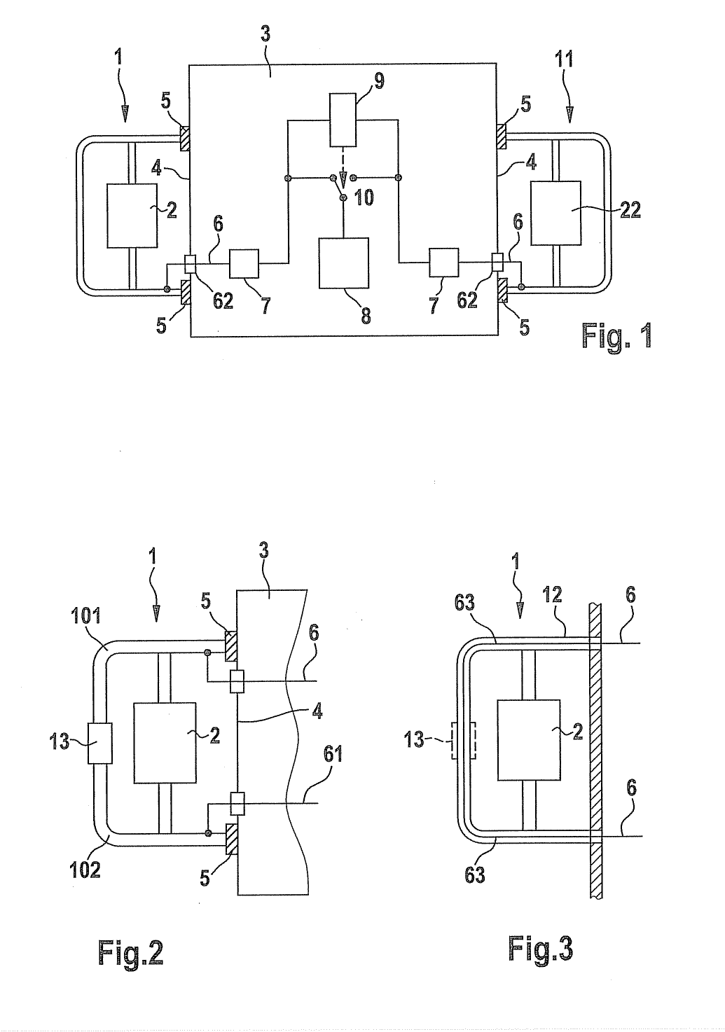

FIG. 1 shows a bracket-like holding device 1 for a rearview mirror 2 of a truck 3. It is normally made of a bracket-shaped metal pipe, the two ends of which are fastened to the metal outer wall 4 of the truck cab and thus to the chassis. If the ends of the pipe of holding device 1 are electrically separated from the chassis by insulations 5, the holding device itself may be used as an antenna. It only needs to be connected to an antenna lead 6 and possibly via an adaptation device 7 to a motor vehicle receiving and/or transmitting device 8. Several such holding devices, for example holding device 11 for rearview mirror 22 on the opposite side together with holding device 1 may form individual elements of a dipole or individual elements for a diversity device 9, which, depending on the measured field strength of the antenna signals of the individual elements 1 and 11, connects each individual element via a switching device 10 through to receiving device 8, which provides the highest received field strength.

FIG. 2 shows the same system as FIG. 1 with the difference that holding device 1 has an insulation point 13 approximately at its center, in particular on the crest of the bracket, at a distance from motor vehicle 3. Holding device 1, 11 thereby forms two mutually electrically insulated parts 101, 102, which may be interconnected as antenna conductors to form a multi-antenna system or a dipole antenna.

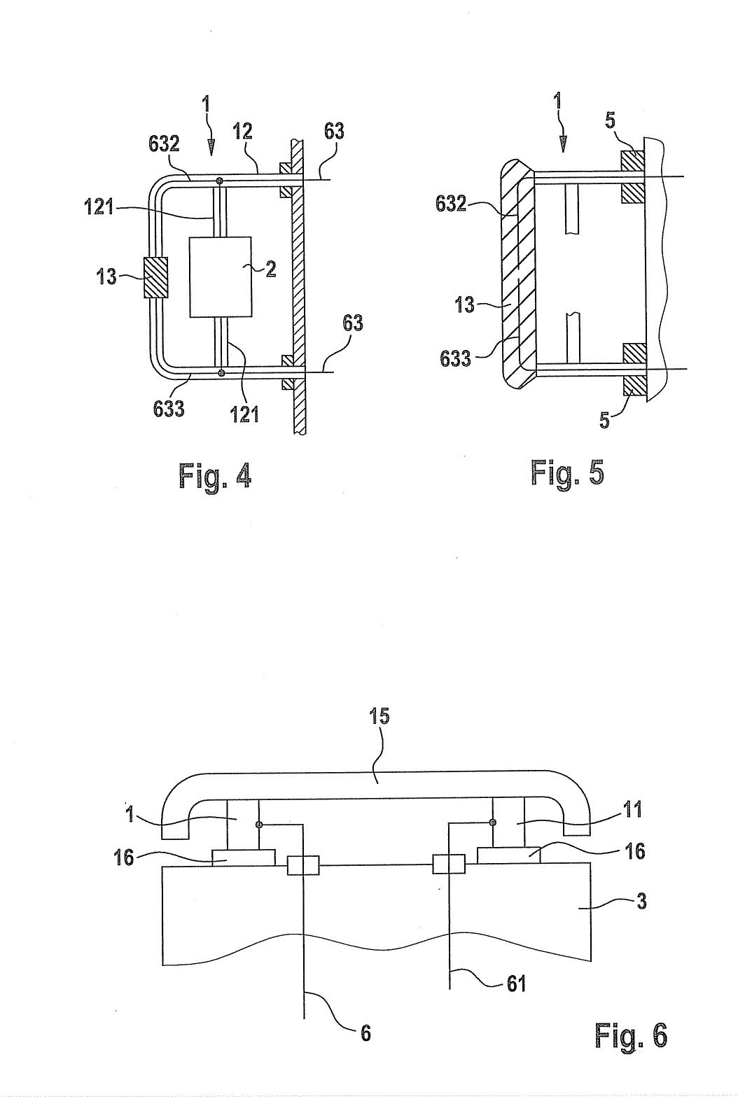

In FIG. 3, antenna lead 6 is not run into the interior of the vehicle via a separate wall duct 62 as in FIGS. 1 and 2, but is rather run onward through inner pipe 12 of holding device 1 as an insulated antenna conductor 63. If, as shown in FIG. 3, antenna conductor 63 is run through or connected to the entire inner pipe of holding device 1, 11, up to the transition to antenna lead 6 when exiting again at the other end of the pipe, an antenna conductor loop is formed, which is suitable for receiving the magnetic field component of a high frequency signal even if holding device 1, 11 is not insulated vis-à-vis the chassis. When matching the resonance, for example by a simple capacitor between the ends of the antenna conductor, a resonant circuit of high quality is produced having a sharp directivity in the direction of travel, which makes the use of this variant advantageous for communicating with vehicles in particular in the same traffic lane and/or for communicating with signal systems in the surroundings of this traffic lane. Even if the metal pipe of holding device 1 and 11 has an insulation point 13, antenna conductor 63 may be run in the shape of a loop through to the two ends of the pipe. This then results in an additional receiving option of the electrical field component in the area of insulation point 13. It is also possible to split antenna conductor 63 in the area of insulation point 13. FIG. 4 shows this variant. This then produces two L-shaped antenna conductors 632 and 633, which may be interconnected to form a folded dipole or used as individual elements for a diversity antenna system. As also shown in FIG. 4, pipe sections 121 leading to mirror 2 may also accommodate antenna conductors so as to produce F-shaped antenna elements, which may be used as antenna elements for different frequency ranges particularly when the free ends are of different length. Insulation point 13 on the crest of the bracket of the holding device may also be elongated in such a way that the free ends of antenna conductors 632 and 633 extend into the insulation (FIG. 5)—which lengthens the antenna for the electrical field component with the possibility of a specific adaptation of the directivity. In addition, because of an extension of insulation point 13 using a suitable plastic, holding device 1, 11 causes fewer scratch marks in particular when maneuvering the truck around buildings or other motor vehicles.

FIG. 6 shows a metal holding device 1 for the front bumper 15 of a motor vehicle 3. If this holding device 1 is electrically isolated from the chassis of motor vehicle 3 by an insulation 16 as shown in FIG. 6, then holding device 1 or another metal holding device 11 for bumper 15 may be used as an antenna and be connected to antenna lead 6 and 61, respectively. Since bumper 15 is normally made of plastic, the two holding devices are not electrically connected to each other. If insulation 16 is lacking and metal holding devices 1 and 11 are made of metal pipe section, then an insulated antenna conductor 64, 65 may be run through or connected to the pipe sections of holding devices 1 and 11, respectively, as shown in FIG. 7. The free ends of antenna conductors 64, 65 continue in bumper 15 and are merely fastened there.

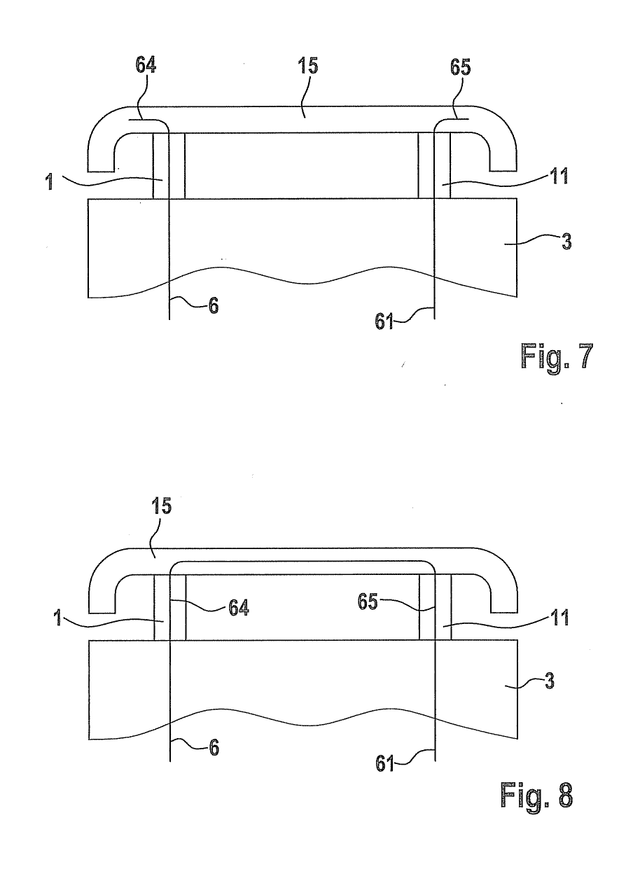

FIG. 8 shows a variant in which the free ends of antenna conductors 64, 65 are interconnected and form a loop. This allows for the implementation of a loop antenna, for example a loop dipole or frame antenna, similar to the variants previously discussed in connection with holding devices for rearview mirrors. Running the antenna conductors 64, 65 in non-metal bumper 15 makes it possible to receive an electric field component in addition to a magnetic field component of an antenna signal. By usual adaptation and dimensioning it is possible specifically to influence the directivities.

Of course, the holding devices for the exterior mirror and the holding devices for bumpers may be combined to form a multi-antenna or diversity system. The combination with already existing customary window-integrated antennas and rod antennas is possible as well in order to achieve specific directivities or receive antenna signals of different frequency ranges such as VHF, LMS, and TV signals, car-to-X signals, or GSM or UMTS signals.

1-10. (canceled)

11. An antenna arrangement for a motor vehicle, comprising:
at least one holding device, which is one of:
insulated vis-à-vis a chassis, for an add-on part and configured as an antenna or as at least a part of an antenna; or
configured to accommodate an insulated antenna conductor.

12. The antenna arrangement of claim 11, wherein the at least one holding device is a pipe-like, metal holding device, and an insulated antenna conductor is run through or connected to the pipe-like, metal holding device, which is not insulated from the chassis and which is operable at least as part of a directional antenna.

13. The antenna arrangement of claim 11, wherein the at least one holding device includes a plurality of holding devices, and wherein an interconnection to form an antenna system is implemented in multiple ones of the plurality of holding devices.

14. The antenna arrangement of claim 13, further comprising:
a switching device for a diversity operating mode.

15. The antenna arrangement of claim 11, wherein the at least one holding device includes multiple pipe-like holding devices, and wherein an antenna conductor is run through or connected to at least two of the holding devices.

16. The antenna arrangement of claim 11, wherein a bumper includes at least one pipe-like holding device, and wherein an antenna conductor is run both through the at least one pipe-like holding device and through at least a part of the bumper.

17. The antenna arrangement of claim 16, wherein the bumper includes at least two pipe-like holding devices, and wherein an antenna conductor, in the form of a loop, is run through or connected to a first one of the pipe-like holding devices, through a part of the bumper at least to a second one of the pipe-like holding devices, and through the second one of the pipe-like holding devices.

18. The antenna arrangement of claim 11, wherein multiple holding devices are connected as individual elements of a dipole.

19. The antenna arrangement of claim 11, wherein the at least one holding device includes a metal holding device that is insulated in one location so as to form two mutually insulated parts, which are interconnectible.

20. A method for implementing an antenna arrangement for a motor vehicle, the method comprising:
using a holding device for an add-on part;
performing one of the following:
(i) insulating the holding device vis-à-vis a chassis, wherein an insulated part is operated as an antenna or as part of an antenna, or
(ii) inserting an insulated antenna conductor into the holding device, which is operated as an antenna or as part of an antenna, wherein there is no insulation of the holding device vis-à-vis the chassis.

21. The antenna arrangement of claim 11, wherein the at least in a pipe-like, metal holding device, which is not insulated from the chassis, an insulated antenna conductor is run through or connected to the holding device, which is operable at least as part of a directional antenna, which is a frame antenna.

22. An antenna arrangement for a motor vehicle, comprising:
at least one holding device, which is not insulated vis-à-vis a chassis, configured to accommodate an insulated antenna conductor.

23. The antenna arrangement of claim 11, wherein the at least one holding device includes a plurality of holding devices, and wherein an interconnection to faun an antenna system is implemented in multiple, similar ones of the plurality of holding devices.

24. The antenna arrangement of claim 11, wherein the at least one holding device includes multiple pipe-like holding devices, and wherein an insulated antenna conductor is run through or connected to at least two of the holding devices.

25. The antenna arrangement of claim 11, wherein a bumper includes at least one pipe-like holding device, and wherein an insulated antenna conductor is run both through the at least one pipe-like holding device and through at least a part of the bumper.

26. The antenna arrangement of claim 16, wherein the bumper includes at least two pipe-like holding devices, and wherein an insulated antenna conductor, in the form of a loop, is nm through or connected to a first one of the pipe-like holding devices, through a part of the bumper at least to a second one of the pipe-like holding devices, and through the second one of the pipe-like holding devices.

27. The antenna arrangement of claim 11, wherein multiple, similar holding devices are connected as individual elements of a dipole.

28. The antenna arrangement of claim 11, wherein the at least one holding device includes a metal holding device that is insulated in one location so as to form two mutually insulated parts, which are interconnectible to form a dipole antenna.
